(19) United States
(12) Patent Application Publication
(10) Pub. No.: US 2006/0003212 A1
(43) Pub. Date: Jan. 5, 2006

(54) Polymer electrolyte membrane, membrane-electrode assembly, fuel cell system, and method for preparing the membrane-electrode assembly

(76) Inventors: Hee-Tak Kim, Suwon-si (KR); Ho-Jin Kweon, Suwon-si (KR)

Correspondence Address: CHRISTIE, PARKER & HALE, LLP, PO BOX 7068, PASADENA, CA, 91109-7068, US

(21) Appl. No.: 11/155,850

(22) Filed: Jun. 16, 2005

(30) Foreign Application Priority Data
Jun. 30, 2004 (KR) 10-2004-0050774

(51) Int. Cl. H01M 8/10; B05D 5/12; H01M 4/88

(52) U.S. Cl. 429/30; 429/33; 427/115; 502/101

(57) ABSTRACT

A polymer electrolyte membrane for a fuel cell includes a proton conductive polymer membrane and proton conductive microfibers coated on either side of the proton conductive polymer membrane.

### CROSS REFERENCE TO RELATED APPLICATION

This application claims priority to and the benefit of Korean Patent Application No. 10-2004-0050774 filed on Jun. 30, 2004 in the Korean Intellectual Property Office, the entire content of which is incorporated herein by reference.

### FIELD OF THE INVENTION

The present invention relates to a polymer electrolyte membrane, a membrane-electrode assembly, a fuel cell system, and a method for preparing a membrane-electrode assembly, and, more particularly, to a polymer electrolyte membrane for a fuel cell having a wide surface area, a membrane-electrode assembly with good efficiency, and a fuel cell system including the same, and a method for preparing the membrane-electrode assembly.

### BACKGROUND OF THE INVENTION

A fuel cell is an electric power generating system for producing electrical energy through a chemical reaction between oxygen and hydrogen included in a hydrocarbon-based material such as methanol, ethanol, or natural gas.

A fuel cell can be classified into a phosphoric acid type, a molten carbonate type, a solid oxide type, a polymer electrolyte type, or an alkaline type, depending upon the kind of electrolyte used. Although each of these different types of fuel cells operates in accordance with the same basic principles, they may differ from one another in the kind of fuel, the operating temperature, the catalyst, and the electrolyte used.

Recently, polymer electrolyte membrane fuel cells (PEMFCs) have been developed. They have power characteristics that are superior to conventional fuel cells, as well as lower operating temperatures, and faster start and response characteristics. Because of this, PEMFCs can be applied to a wide array of fields, such as for transportable electrical sources for automobiles, distributed power sources for houses and public buildings, and small electrical sources for electronic devices.

A PEMFC is essentially composed of a stack, a reformer, a fuel tank, and a fuel pump. The stack forms a body of the PEMFC, and the fuel pump provides fuel stored in the fuel tank to the reformer. The reformer reforms the fuel to generate hydrogen gas and supplies the hydrogen gas to the stack, where it is electrochemically reacted with oxygen to generate electrical energy.

Alternatively, a fuel cell may include a direct methanol fuel cell (DMFC) in which liquid methanol fuel is directly introduced to the stack. Unlike a PEMFC, a DMFC does not require a reformer.

In a fuel cell system described above, the stack for generating the electricity has a structure in which several unit cells, each having a membrane-electrode assembly (MEA) and a separator (also referred to as a bipolar plate), are stacked adjacent one another. The MEA has a structure in which a polymer electrolyte membrane is positioned and adhered between an anode (also referred to as a fuel electrode or an oxidation electrode) and a cathode (also referred to as an air electrode or a reduction electrode).

The separators function both as passageways for supplying the fuel and the oxygen necessary for a reaction of the fuel cell to the anode and the cathode, as well as conductors for serially connecting the anode and the cathode of each MEA. The electrochemical oxidation reaction of the fuel occurs at the anode, and the electrochemical reduction reaction of the oxygen occurs at the cathode. Due to movement of the electrons generated by the reactions, electricity, heat, and water are collectively produced.

The anode and the cathode typically include a platinum catalyst. However, since platinum is too expensive a noble metal to be used in large quantities, platinum is typically supported on a carbon layer to reduce the amount of the platinum used.

However, supporting the platinum catalyst on the carbon can result in certain shortcomings, such as a thick catalyst layer, a catalyst layer having limited platinum storage capabilities, or a deterioration of a fuel cell due to a bad contact condition between a catalyst layer and an electrolyte membrane.

Therefore, it is desirable to develop an MEA that has a good cell capacity even when the amount of the catalyst included in the catalyst layer of the MEA is reduced.

### SUMMARY OF THE INVENTION

An embodiment of the present invention provides a polymer electrolyte membrane for a fuel cell with a high specific surface area.

An embodiment of the present invention provides a membrane-electrode assembly (MEA) in which the specific surface area of a catalyst is high.

An embodiment of the present invention provides a fuel cell system including the polymer electrolyte membrane with the high specific surface area.

An embodiment of the present invention provides a method for preparing the MEA in which the specific surface area of the catalyst is high.

One embodiment of the present invention provides a polymer electrolyte membrane for a fuel cell including a proton conductive polymer membrane and proton conductive microfibers coated on either side of the polymer membrane.

One embodiment of the present invention also provides a membrane-electrode assembly including a polymer electrolyte membrane for a fuel cell having a proton conductive polymer membrane and proton conductive microfibers coated on either side of the polymer membrane, a catalyst layer coated on either side of the polymer electrolyte membrane, and a gas diffusion layer positioned on the catalyst layer.

One embodiment of the present invention provides a fuel cell system. The fuel cell includes an electricity generating unit including separators and a membrane-electrode assembly between the separators, the membrane-electrode assembly including an anode and a cathode and a polymer electrolyte membrane between the anode and the cathode; a fuel supplying unit for supplying fuel including hydrogen or methanol to the electricity generating unit; and an oxidizing agent supplying unit for supplying oxidizing agent to the electricity generating unit. In this embodiment, the polymer electrolyte membrane includes a proton conductive polymer membrane, and a proton conductive microfiber coated on either side of the polymer membrane.

One embodiment of the present invention provides a method for preparing a membrane-electrode assembly. The method includes a process in which a proton conductive polymer membrane is coated with proton conductive microfibers to prepare a polymer electrolyte membrane for a fuel cell; a catalyst is deposited on either side of the polymer electrolyte membrane for the fuel cell to form a catalyst layer; and a gas diffusion layer is positioned on the catalyst layer.

### BRIEF DESCRIPTION OF THE DRAWINGS

FIG. 1 is a plan view-schematically showing one side of a polymer electrolyte membrane for a fuel cell according to the present invention;

FIG. 2 is a cross sectional view schematically showing a membrane-electrode assembly (MEA) according to the present invention;

FIG. 3 is a cross sectional view schematically showing an MEA according to the present invention further including a microporous layer;

FIG. 4 is a schematic diagram illustrating a fuel cell system in accordance with the present invention;

FIG. 5 is an exploded perspective view schematically showing a electricity generating unit including a polymer electrolyte membrane for a fuel cell according to the present invention; and

FIG. 6 is a scanning electron microscope photograph of a polymer electrolyte membrane according to Example 1.

### DETAILED DESCRIPTION

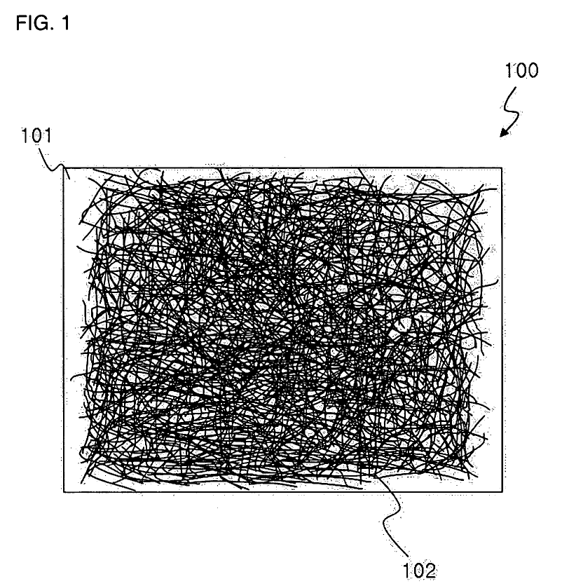

FIG. 1 is a plan view schematically showing one side of a polymer electrolyte membrane 100 for a fuel cell according to the present invention. Referring to FIG. 1, the polymer electrolyte membrane 100 for the fuel cell according to the present invention includes a proton conductive polymer membrane 101 and proton conductive microfibers 102 coated on either side of the proton conductive polymer membrane 101.

In one embodiment, the proton conductive polymer membrane 101 includes a proton conductive polymer such as is typically used as an electrolyte membrane material for a fuel cell. Exemplary materials for the proton conductive polymer membrane 101 include perfluoro-based polymers, benzimidazole-based polymers, polyimide-based polymers, polyetherimide-based polymers, polyphenylenesulfide-based polymers, polysulfone-based polymers, polyethersulfone-based polymers, polyetherketone-based polymers, polyether-etherketone-based polymers, polyphenylquinoxaline-based polymers, and combinations thereof. Preferred proton conductive polymers include poly(perfluorosulfonic acid), poly(perfluorocarboxylic acid), copolymers of fluorovinylether and tetrafluoroethylene including sulfonic acid groups, defluorinated polyetherketone sulfide, arylketones, poly(2,2′-(m-phenylene)-5,5′-bibenzimidazole), poly(2,5-benzimidazole), and combinations thereof. However, the proton conductive polymer membrane 101 of FIG. 1 included in the polymer electrolyte membrane 100 according to the present invention is not limited thereto.

In one embodiment, the average diameter of a proton conductive microfiber 102 which is coated on either side of the proton conductive polymer membrane 101 is from 0.01 to 5 μm, and more preferably from 0.01 to 0.5 μm. When the average diameter of the microfiber is less than 0.01 μm, the process for preparing the microfibers 102 becomes difficult due to the high voltage needed for preparing them. Alternatively, when the average diameter is more than 5 μm, the increase of the surface area is not sufficient.

In one embodiment, the proton conductive microfibers 102 are coated on either side of the proton conductive polymer membrane 101 by an electrospinning method in which a polymer is spun by applying a potential difference to a polymer melt or a polymer solution.

In one embodiment, the proton conductive microfibers 102 includes a proton conductive polymer such as is typically used as an electrolyte membrane material for a fuel cell. Exemplary materials for the proton conductive microfibers 102 include perfluoro-based polymers, benzimidazole-based polymers, polyimide-based polymers, polyetherimide-based polymers, polyphenylenesulfide-based polymers, polysulfone-based polymers, polyethersulfone-based polymers, polyetherketone-based polymers, polyether-etherketone-based polymers, polyphenylquinoxaline-based polymers, and combinations thereof. Preferred proton conductive polymers include poly(perfluorosulfonic acid), poly(perfluorocarboxylic acid), copolymers of fluorovinylether and tetrafluoroethylene including sulfonic acid groups, defluorinated polyetherketone sulfide, arylketones, poly(2,2′-(m-phenylene)-5,5′-bibenzimidazole), poly(2,5-benzimidazole), and combinations thereof. However, the proton conductive microfibers 102 included in the polymer electrolyte membrane 100 for the fuel cell according to the present invention are not limited thereto.

In view of FIG. 1, since the surface area of either side of the polymer electrolyte membrane 100 is large due to the proton conductive microfibers 102, the area capable of contacting with a catalyst layer of a membrane-electrode assembly (MEA) is also increased, thereby improving the efficiency of the fuel cell.

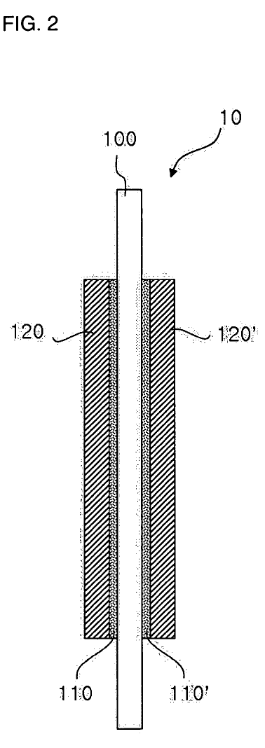

FIG. 2 is a cross sectional view schematically showing an MEA 10 according to the present invention. Referring to FIG. 2, the MEA 10 includes the polymer electrolyte membrane 100 for the fuel cell of FIG. 1. In addition, the MEA 10 includes catalyst layers 110, 110′ coated on either side of the polymer electrolyte membrane 100 using a process such as deposition, and gas diffusion layers 120, 120′ respectively positioned on the catalyst layers 110, 110′.

In one embodiment of the present invention, the content of the catalyst in at least one of the catalyst layers 110, 110′ is from 0.001 to 0.5 mg/cm², more preferably, from 0.01 to 0.05 mg/cm². When the content of the catalyst in the catalyst layers 110, 110′ is less than 0.001 mg/cm², output power of the fuel cell is not sufficient. Alternatively, when the content of the catalyst in the catalyst layers 110, 110′ is more than 0.5 mg/cm², optimal utilization of the catalyst may be reduced.

Furthermore, in one embodiment, the specific surface area of the catalyst included in the catalyst layers 110, 110′ is in the range of from 10 to 500 m²/g. Since the oxidation/reduction reaction of the fuel cell occurs at the surface of the catalyst, the larger the specific surface area, the better the efficiency of the fuel cell. Therefore, when the specific surface area of the catalyst is less than 10 m²/g, the efficiency of the fuel cell is reduced. However, when it is more than 500 m²/g, the process for preparing it becomes difficult.

In one embodiment, the catalyst layers 110, 110′ includes a catalyst selected from the group consisting of platinum, ruthenium, osmium, platinum-ruthenium alloys, platinum-osmium alloys, platinum-palladium alloys, and platinum-M alloys (where M is at least one transition metal selected from the group consisting of Ga, Ti, V, Cr, Mn, Fe, Co, Ni, Cu, and Zn) and combinations thereof. Preferred catalysts include platinum, ruthenium, osmium, platinum-ruthenium alloys, platinum-osmium alloys, platinum-palladium alloys, platinum-cobalt alloys, platinum-nickel alloys, and combinations thereof.

As shown in FIG. 2, the gas diffusion layers (GDL) 120, 120′ are respectively positioned on the catalyst layers 110,110′. The gas diffusion layers 120, 120′ are for supplying hydrogen gas and oxygen gas to the respective catalyst layers 110, 110′, to help form a three-phase interface of catalyst-electrolyte membrane-gas. In one embodiment, at least one of the gas diffusion layers 120, 120′ is made of a carbon paper or a carbon cloth.

A microporous layer (MPL) may be further included between the catalyst layers 110, 110′ and the gas diffusion layers 120, 120′, to help diffusion of the hydrogen gas and the oxygen gas.

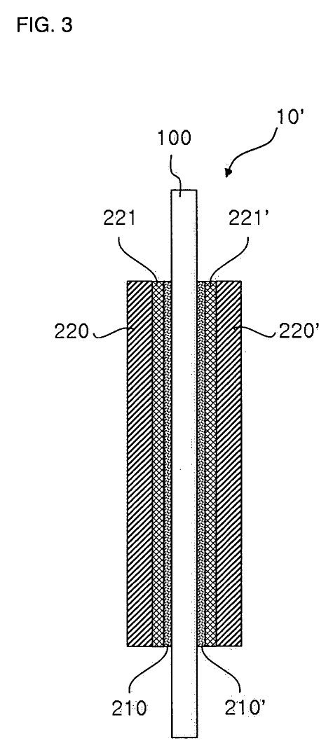

FIG. 3 is a cross-sectional view schematically showing a membrane-electrode assembly (MEA) 10′ according to such an embodiment of the present invention. Similar to the previous embodiment, MEA 10′ includes a polymer electrolyte membrane 100, catalyst layers 210, 210′ and gas diffusion layers 220, 220′ with the difference being which the inclusion of microporous layers (MPLs) 221, 221′ between the catalyst layers 210, 210′ and gas diffusion layers 220, 220′.

In one embodiment, each of the microporous layers 221, 221′ is a carbon layer in which micropores of a few μm or less are formed, and preferably, it comprises a material selected from the group consisting of graphite, carbon nanotube (CNT), fullerene (C60), activated carbon, carbon black, and combinations thereof.

The catalyst of the catalyst layers of either embodiment may be coated by direct deposition of the catalyst, and such catalyst layers have excellent performance due to their large surface areas.

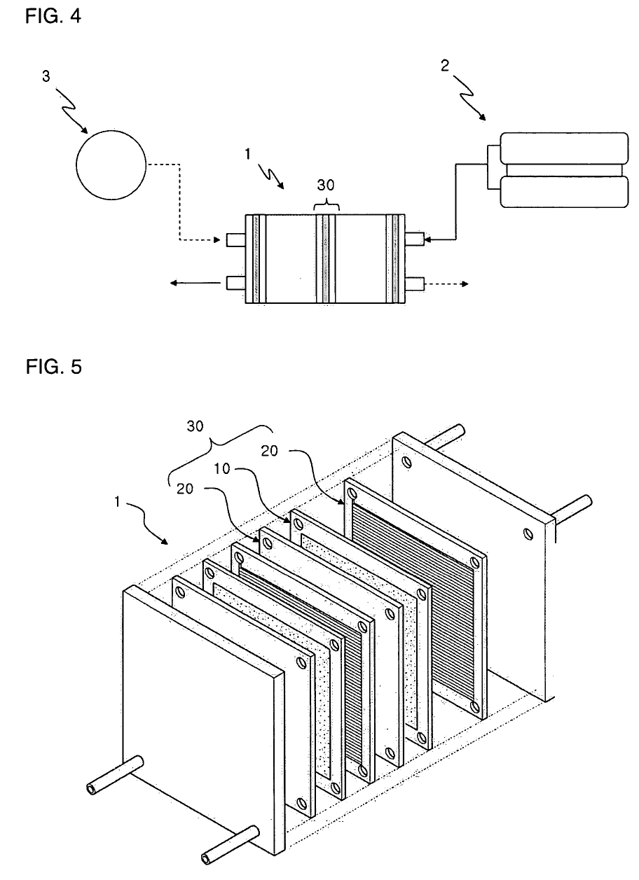

FIG. 4 is a schematic diagram illustrating a fuel cell system in accordance with the present invention, and FIG. 5 is an exploded perspective view schematically showing a electricity generating unit 1 including a polymer electrolyte membrane (e.g., the polymer electrolyte membrane 100 of FIG. 1) according to the present invention.

Referring to FIGS. 4 and 5, the fuel cell system of the present invention includes a fuel supply unit 2 for supplying fuel including hydrogen, an oxidizing agent supply unit 3 for supplying oxidizing agent (such as oxygen contained in air), and an electricity generating unit 1 for generating electricity by performing electrochemical reactions of the fuel and the oxidizing agent.

Furthermore, the electricity generating unit 1 of the present invention includes at least one unit cell 30 which includes the membrane-electrode assembly 10 including the polymer electrolyte membrane 100, and an anode and a cathode positioned on either side of the polymer electrolyte membrane 100, and separators 20. The membrane-electrode assembly 10 is between the separators 20, and the polymer electrolyte membrane 100 of the membrane-electrode assembly 10 includes the proton conductive polymer membrane 101, and the proton conductive microfibers 102 coated on either side of the proton conductive polymer membrane 101.

A method for preparing a membrane-electrode assembly according to the present invention includes: a process in which proton conductive microfibers are coated on either side of a proton conductive polymer membrane to prepare a polymer electrolyte membrane for a fuel cell; a process in which catalyst is deposited on either side of the above-mentioned polymer electrolyte membrane to form a catalyst layer; and a process in which a gas diffusion layer is positioned on the catalyst layer.

In one embodiment, the proton conductive polymer membrane used for preparing the membrane-electrode assembly includes a proton conductive polymer such as is typically used as an electrolyte membrane material for a fuel cell. Examples of such proton conductive polymers include perfluoro-based polymers, benzimidazole-based polymers, polyimide-based polymers, polyetherimide-based polymers, polyphenylenesulfide-based polymers, polysulfone-based polymers, polyethersulfone-based polymers, polyetherketone-based polymers, polyether-etherketone-based polymers, polyphenylquinoxaline-based polymers, and combinations thereof. Preferred proton conductive polymers include poly(perfluorosulfonic acid), poly(perfluorocarboxylic acid), copolymers of fluorovinylether and tetrafluoroethylene including sulfonic acid groups, defluorinated polyetherketone sulfide, arylketones, poly(2,2′-(m-phenylene)-5,5′-bibenzimidazole), poly(2,5-benzimidazole), and combinations thereof. However, the proton conductive polymer membrane included in the polymer electrolyte membrane for the fuel cell according to the present invention is not limited thereto.

In one embodiment, the proton conductive microfibers used for preparing the above-mentioned membrane-electrode assembly include a proton conductive polymer. Exemplary materials for the proton conductive microfiber include perfluoro-based polymers, benzimidazole-based polymers, polyimide-based polymers, polyetherimide-based polymers, polyphenylenesulfide-based polymers, polysulfone-based polymers, polyethersulfone-based polymers, polyetherketone-based polymers, polyether-etherketone-based polymers, polyphenylquinoxaline-based polymers, and combinations thereof. Preferred proton conductive polymers include poly(perfluorosulfonic acid), poly(perfluorocarboxylic acid), copolymers of fluorovinylether and tetrafluoroethylene including sulfonic acid groups, defluorinated polyetherketone sulfide, arylketones, poly(2,2′-(m-phenylene)-5,5′-bibenzimidazole), poly(2,5-benzimidazole), and combinations thereof. However, the materials for the proton conductive microfibers used for preparing the membrane-electrode assembly according to the present invention are not limited thereto.

The above-mentioned proton conductive microfibers may be coated by an electrospinning method on either side of the proton conductive polymer membrane. The electrospinning method is a technology in which a large potential differential is applied between a grounded collecting screen and a proton conductive polymer melt or a proton conductive polymer solution. A non-woven mat is prepared by the electrospinning method, and the microfibers produced by such method have a very large surface area. In more detail, an electrospinning method can be achieved in accordance with an article in, Applied Chemistry, Vol. 2, No. 2, 1998, which is incorporated by reference herein in its entirety. However, the scope of the present invention is not limited by the above described electrospinning method, and those skilled in the art would recognize that the method may be varied by other suitable methods.

In one embodiment of the present invention, the voltage applied to the proton conductive polymer melt or the proton conductive polymer solution is from 1 to 1000 kV, and preferably from 5 to 25 kV.

Catalyst is coated by deposition on either side of the polymer electrolyte membrane to form the catalyst layer. In one embodiment, the content of the catalyst included in the catalyst layer is from 0.001 to 0.5 mg/cm², and preferably from 0.01 to 0.05 mg/cm².

Suitable deposition methods for depositing the catalyst include sputtering, thermal chemical vapor deposition (CVD), plasma enhanced CVD (PECVD), thermal evaporation, electrochemical deposition, and e-beam evaporation methods.

In one embodiment, the catalyst layer includes a material selected from the group consisting of platinum, ruthenium, osmium, platinum-ruthenium alloys, platinum-osmium alloys, platinum-palladium alloys, platinum-M alloys (where M is at least one kind of transition metal selected from the group consisting of Ga, Ti, V, Cr, Mn, Fe, Co, Ni, Cu, and Zn), and combinations thereof. Preferred catalysts include platinum, ruthenium, osmium, platinum-ruthenium alloys, platinum-osmium alloys, platinum-palladium alloys, platinum-cobalt alloys, platinum-nickel alloys, and combinations thereof.

The gas diffusion layer is positioned on the catalyst layer. The gas diffusion layer plays a role in vigorously supplying hydrogen gas and/or oxygen gas to the catalyst layer, to help in forming a three-phase interface of the catalyst-electrolyte membrane-gas, and in one embodiment is made of a carbon paper or a carbon cloth.

A microporous layer may be additionally positioned between the catalyst layer and the gas diffusion layer to help diffusion of the hydrogen gas and/or the oxygen gas.

In one embodiment, the microporous layer is a carbon layer in which micropores are formed, and preferably includes a material selected from the group consisting of graphite, carbon nanotube (CNT), fullerene (C60), activated carbon, carbon black, and combinations thereof.

In view of the foregoing, a membrane-electrode assembly of the present invention includes a catalyst layer coated by direct deposition of catalyst, and has a catalyst layer with excellent performance due to its large surface area, thereby improving the performance of the membrane-electrode assembly.

The following examples further illustrate the present invention in more detail, but the present invention is not limited by these examples.

### EXAMPLE 1

### Preparation of a Polymer Electrolyte Membrane

After a poly(perfluorosulfonic acid) membrane (DuPont Co. Nafion® 112) was set on a grounded collecting screen in a chamber having a nozzle, a poly(perfluorosulfonic acid) solution (DuPont Co. Nafion® solution) was put into the nozzle, and a voltage of 50 kV was applied to the solution. While the solution was released from the nozzle by the potential difference, poly(perfluorosulfonic acid) microfibers having an average diameter of 0.1 μm were coated on one side of the poly(perfluorosulfonic acid) membrane (Nafion® 112, Dupont).

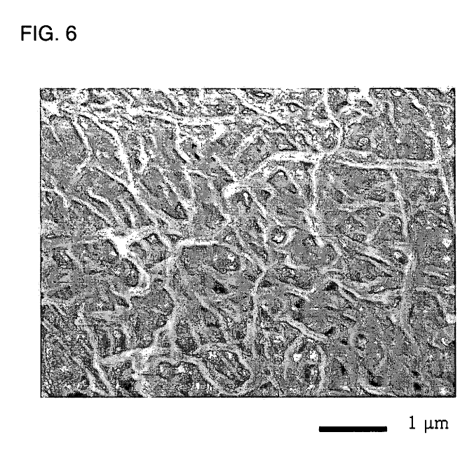

By the same process, poly(perfluorosulfonic acid) microfibers were coated on the other side of the poly(perfluorosulfonic acid) membrane (Nafion® 112, Dupont) to prepare a polymer electrolyte membrane. FIG. 6 is a scanning electron microscope photograph of a surface of the polymer electrolyte membrane prepared according to above-mentioned process.

### EXAMPLE 2

### Preparation of a Membrane-Electrode Assembly

Platinum was deposited by sputtering on either side of the polymer electrolyte membrane prepared according to Example 1 to form a catalyst layer having 0.04 mg/cm² of platinum.

Moreover, a carbon cloth, covered with a microporous layer consisting of activated carbon, was positioned on each catalyst layer to prepare a membrane-electrode assembly.

### EXAMPLE 3

### Preparation of a Fuel Cell

Separators were positioned on either side of the membrane-electrode assembly prepared according to Example 2 to prepare a fuel cell.

### COMPARATIVE EXAMPLE 1

### Preparation of a Membrane-Electrode Assembly

Platinum was deposited by sputtering on either side of a polymer electrolyte membrane to form a catalyst layer having 0.04 mg/cm² of platinum without coating a microfiber on the poly(perfluorosulfonic acid) membrane (Nafion® 112). The poly(perfluorosulfonic acid) membrane on which platinum was deposited was positioned between two sheets of carbon cloth covered with a microporous layer consisting of an activated carbon substantially in the same manner as in Example 2, to prepare a membrane-electrode assembly.

### COMPARATIVE EXAMPLE 2

### Preparation of a Fuel Cell

Separators were stacked on either side of the membrane-electrode assembly prepared according to Comparative Example 1 to produce a fuel cell.

Table. 1 shows the specific surface area of the catalyst layers in the preparation process of the membrane-electrode assemblies according to Example 2 and Comparative Example 1.

TABLE 1

| | | Comparative |
|---|---|---|
| | Example 2 | Example 1 |
| Specific surface area of catalyst layer | 25 | 3 |
| (m²/g) | | |

As shown in Table 1, the specific surface area of the catalyst layer in the membrane-electrode assembly prepared according to Example 2 is higher by a factor of more than 8 as compared to Comparative Example 1.

Table 2 shows current densities estimated at 60° C., after vapor-saturated oxygen and hydrogen gases were injected respectively to the cathodes and anodes of fuel cells prepared according to Example 3 and Comparative Example 2.

TABLE 2

| | Example 3 | Comparative Example 2 |
|---|---|---|
| Current density(A/cm²) at 0.6 V | 1.3 | 0.2 |

As shown in Table 2, the current density of the fuel cell in Example 2, including the membrane-electrode assembly according to the present invention, is 6 times higher than that of Comparative Example 1.

In view of the foregoing, since catalyst is coated by deposition directly on either of a polymer electrolyte membrane for a fuel cell with a high specific surface area in a membrane-electrode assembly according to the present invention, the specific surface area of the catalyst is high, and consequently the capability of a fuel cell is improved.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. A polymer electrolyte membrane for a fuel cell, comprising:
a proton conductive polymer membrane; and
proton conductive microfibers coated on either side of the polymer membrane.

2. The polymer electrolyte membrane for the fuel cell according to claim 1, wherein the proton conductive polymer membrane comprises a material selected from the group consisting of perfluoro-based polymers, benzimidazole-based polymers, polyimide-based polymers, polyetherimide-based polymers, polyphenylenesulfide-based polymers, polysulfone-based polymers, polyethersulfone-based polymers, polyetherketone-based polymers, polyether-etherketone-based polymers, polyphenylquinoxaline-based polymers, and combinations thereof.

3. The polymer electrolyte membrane for the fuel cell according to claim 1, wherein the proton conductive polymer membrane comprises a proton conductive polymer selected from the group consisting of poly(perfluorosulfonic acid), poly(perfluorocarboxylic acid), and copolymers of fluorovinylether and tetrafluoroethylene including sulfonic acid groups, defluorinated polyetherketone sulfide, arylketones, poly(2,2′-(m-phenylene)-5,5′-bibenzimidazole), poly(2,5-benzimidazole), and combinations thereof.

4. The polymer electrolyte membrane for the fuel cell according to claim 1, wherein an average diameter of the proton conductive microfibers is from 0.01 to 5 μm.

5. The polymer electrolyte membrane for the fuel cell according to claim 1, wherein the proton conductive microfibers are coated by an electrospinning method.

6. The polymer electrolyte membrane for the fuel cell according to claim 1, wherein the proton conductive microfibers comprise a material selected from the group consisting of perfluoro-based polymers, benzimidazole-based polymers, polyimide-based polymers, polyetherimide-based polymers, polyphenylenesulfide-based polymers, polysulfone-based polymers, polyethersulfone-based polymers, polyetherketone-based polymers, polyether-etherketone-based polymers, polyphenylquinoxaline-based polymers, and combinations thereof.

7. The polymer electrolyte membrane for the fuel cell according to claim 1, wherein the proton conductive microfibers comprise a proton conductive polymer selected from the group consisting of poly(perfluorosulfonic acid), poly(perfluorocarboxylic acid), copolymers of fluorovinylether and tetrafluoroethylene including sulfonic acid groups, defluorinated polyetherketone sulfide, arylketones, poly(2,2′-(m-phenylene)-5,5′-bibenzimidazole), poly(2,5-benzimidazole), and combinations thereof.

8. A membrane-electrode assembly comprising:
a polymer electrolyte membrane for a fuel cell having a proton conductive polymer membrane and proton conductive microfibers coated on either side of the polymer membrane;
a catalyst layer coated on either side of the polymer electrolyte membrane; and
a gas diffusion layer positioned on the catalyst layer.

9. The membrane-electrode assembly according to claim 8, wherein the catalyst layer comprises a catalyst provided in an amount from 0.001 to 0.5 mg/cm².

10. The membrane-electrode assembly according to claim 8, wherein the catalyst layer comprises a catalyst with a specific surface area between 10 and 500 m²/g.

11. The membrane-electrode assembly according to claim 8, wherein the catalyst layer comprises a material selected from the group consisting of platinum, ruthenium, osmium, platinum-ruthenium alloys, platinum-osmium alloys, platinum-palladium alloys, and platinum-M alloys, where M is a transition metal selected from the group consisting of Ga, Ti, V, Cr, Mn, Fe, Co, Ni, Cu, and Zn, and combinations thereof.

12. The membrane-electrode assembly according to claim 8, wherein the gas diffusion layer comprises a material selected from the group consisting of carbon paper and carbon cloth.

13. The membrane-electrode assembly according to claim 8, further comprising a microporous layer (MPL) between the catalyst layer and the gas diffusion layer.

14. The membrane-electrode assembly according to claim 13, wherein the MPL comprises a material selected from the group consisting of graphite, carbon nanotube (CNT), fullerene (C60), activated carbon, carbon black, and combinations thereof.

15. A fuel cell system, comprising:
an electricity generating unit including separators and a membrane-electrode assembly between the separators, the membrane-electrode assembly including an anode and a cathode and a polymer electrolyte membrane between the anode and the cathode;
a fuel supply unit for supplying fuel to the electricity generating unit; and
an oxidizing agent supply unit for supplying oxidizing agent to the electricity generating unit,
wherein the polymer electrolyte membrane comprises a proton conductive polymer membrane, and proton conductive microfibers coated on either side of the polymer membrane.

16. A method for preparing a membrane-electrode assembly comprising:
coating a proton conductive polymer membrane with proton conductive microfibers to prepare a polymer electrolyte membrane for a fuel cell;
depositing a catalyst on either side of the polymer electrolyte membrane to form a catalyst layer; and
positioning a gas diffusion layer on the catalyst layer.

17. The method for preparing a membrane-electrode assembly according to claim 16, wherein the proton conductive polymer membrane comprises a material selected from the group consisting of perfluoro-based polymers, benzimidazole-based polymers, polyimide-based polymers, polyetherimide-based polymers, polyphenylenesulfide-based polymers, polysulfone-based polymers, polyethersulfone-based polymers, polyetherketone-based polymers, polyether-etherketone-based polymers, polyphenylquinoxaline-based polymers, and combinations thereof.

18. The method for preparing a membrane-electrode assembly according to claim 16, wherein the proton conductive polymer membrane comprises a proton conductive polymer selected from the group consisting of poly(perfluorosulfonic acid), poly(perfluorocarboxylic acid), copolymers of fluorovinylether and tetrafluoroethylene including sulfonic acid groups, defluorinated polyetherketone sulfide, arylketones, poly(2,2′-(m-phenylene)-5,5′-bibenzimidazole), poly(2,5-benzimidazole), and combinations thereof.

19. The method for preparing a membrane-electrode assembly according to claim 16, wherein the proton conductive microfibers comprise a material selected from the group consisting of perfluoro-based polymers, benzimidazole-based polymers, polyimide-based polymers, polyetherimide-based polymers, polyphenylenesulfide-based polymers, polysulfone-based polymers, polyethersulfone-based polymers, polyetherketone-based polymers, polyether-etherketone-based polymers, polyphenylquinoxaline-based polymers, and combinations thereof.

20. The method for preparing a membrane-electrode assembly according to claim 16, wherein the proton conductive microfibers comprise a proton conductive polymer selected from the group consisting of poly(perfluorosulfonic acid), poly(perfluorocarboxylic acid), copolymers of fluorovinylether and tetrafluoroethylene including sulfonic acid groups, defluorinated polyetherketone sulfide, arylketones, poly(2,2′-(m-phenylene)-5,5′-bibenzimidazole), poly(2,5-benzimidazole), and combinations thereof.

21. The method for preparing a membrane-electrode assembly according to-claim 16, wherein the coating of the proton conductive polymer membrane with the proton conductive microfibers is performed by an electrospinning method.

22. The method for preparing a membrane-electrode assembly according to claim 16, wherein the catalyst layer is formed using a method selected from sputtering, thermal chemical vapor deposition (CVD), plasma enhanced CVD (PECVD), thermal evaporation, electrochemical deposition, e-beam evaporation, and combinations thereof.

23. The method for preparing a membrane-electrode assembly according to claim 16, wherein the catalyst is provided an amount between 0.001 and 0.5 mg/cm².

24. The method for preparing a membrane-electrode assembly according to claim 16, wherein the catalyst layer comprises a material selected from the group consisting of platinum, ruthenium, osmium, platinum-ruthenium alloys, platinum-osmium alloys, platinum-palladium alloys, platinum-M alloys, and combinations thereof, wherein M is a transition metal selected from the group consisting of Ga, Ti, V, Cr, Mn, Fe, Co, Ni, Cu, and Zn.

25. The method for preparing a membrane-electrode assembly according to claim 16, wherein the gas diffusion layer comprises a material selected from the group consisting of carbon paper and carbon cloth.

26. The method for preparing a membrane-electrode assembly according to claim 16, further comprising forming a microporous layer (MPL) between the catalyst layer and the gas diffusion layer.

27. The method for preparing a membrane-electrode assembly according to claim 26, wherein the MPL comprises a material selected from the group consisting of graphite, carbon nanotube (CNT), fullerene (C60), activated carbon, carbon black, and combinations thereof.
